(19) United States
(12) Patent Application Publication
(10) Pub. No.: US 2004/0064300 A1
(43) Pub. Date: Apr. 1, 2004

(54) Method and apparatus for starting simulation of a computer system from a process checkpoint within a simulator

(76) Inventors: Bernd J.W. Mathiske, Cupertino, CA (US); Paul Caprioli, Mountain View, CA (US)

Correspondence Address: PARK, VAUGHAN & FLEMING LLP, 508 SECOND STREET, SUITE 201, DAVIS, CA, 95616, US

(21) Appl. No.: 10/259,722

(22) Filed: Sep. 26, 2002

(51) Int. Cl. G06F 9/45

(52) U.S. Cl. 703/22

(57) ABSTRACT

One embodiment of the present invention provides a system that facilitates commencing simulation of a process from a process checkpoint, wherein the process checkpoint was created from the process while the process was running outside of a simulator. The system starts by resuming simulation of a restart application within the simulator, wherein the restart application restarts processes from a checkpointed state outside of the simulator. The simulation of this restart application is resumed at a point where the restart application is ready to accept a checkpoint to be restarted. Once simulation of the restart application is resumed, the simulator uses the simulation of the restart application to restart the process from the checkpoint. In this way, simulation of the process can be commenced from the process checkpoint, without the time-consuming task of having to run the process within the simulator up to the point where the checkpoint was created.

### BACKGROUND

1. Field of the Invention

The present invention relates to the process of simulating a computer system. More specifically, the present invention relates to a method and an apparatus for starting simulation of a computer system from a process checkpoint that was created outside of the simulator.

2. Related Art

Modern tools for designing computer systems presently allow a computer system to be extensively simulated before it is implemented. This allows many features of a computer system to be tested and debugged prior to implementing the computer system. Debugging a computer system in this way can significantly reduce the time involved in the design process because it is much easier to modify the design in software before the design is implemented in hardware. Moreover, as advances in integrated circuit technology allow most of the circuitry within a computer system to be integrated into a few monolithic semiconductor chips, a design change typically requires one of these monolithic chips to be redesigned and re-fabricated at a considerable cost. Hence, it is essential to minimize the number of hardware modifications that have to be made during the design process.

Unfortunately, simulation can be extremely time consuming. In many cases, executing a program within a simulator can take hundreds or even thousands of times longer than executing the same program outside of the simulator. In many cases, this makes it impractical to simulate realistic computational workloads, because simulating even a few minutes of computational activity can take days, if not weeks. To make matters worse, in order to debug a computer system, it is often desirable to simulate a program from a specific starting point during execution of the program. In order to perform such simulations in existing systems, the program must first be simulated to the starting point. This can take many weeks or months if the starting point is past the system initialization and warm up phases. To make matters worse, it is often desirable to simulate a program multiple times from the same starting point. In this case, existing simulation systems must simulate the program up to the starting point for each additional simulation, which can take a prohibitive amount of time.

What is needed is a method and an apparatus for simulating programs without the problems described above.

### SUMMARY

One embodiment of the present invention provides a system that facilitates commencing simulation of a process from a process checkpoint, wherein the process checkpoint was created from the process while the process was running outside of a simulator. The system starts by resuming simulation of a restart application within the simulator, wherein the restart application restarts processes from a checkpointed state outside of the simulator. The simulation of this restart application is resumed at a point where the restart application is ready to accept a checkpoint to be restarted. Once simulation of the restart application is resumed, the simulator uses the simulation of the restart application to restart the process from the checkpoint. In this way, simulation of the process can be commenced from the process checkpoint, without the time-consuming task of having to run the process within the simulator up to the point where the checkpoint was created.

In a variation on this embodiment, resuming simulation of a restart application involves loading a restart checkpoint into the simulator, wherein the restart checkpoint was previously generated by the simulator during execution of the restart application within the simulator.

In a further variation, prior to resuming simulation of the restart application, the restart checkpoint is generated by: starting an operating system within the simulator; starting the restart application within the operating system within the simulator; and when the restart application reaches a point where the restart application can accept a restart request, creating the restart checkpoint.

In a variation on this embodiment, the process checkpoint is generated by executing the process outside of the simulator until the process reaches a pre-specified point. Once the process reaches the pre-specified point, the system creates the process checkpoint.

In a variation on this embodiment, the restart application is configured to run as a server that continually accepts restart requests.

One embodiment of the present invention provides a system that facilitates commencing simulation of a process from a process checkpoint, wherein the process checkpoint was created from the process while the process was running outside of a simulator. The system starts by converting the process checkpoint into a form that is useable by the simulator's checkpoint program. Once the checkpoint has been converted, the system commences simulation of the process inside the simulator.

### BRIEF DESCRIPTION OF THE FIGURES

FIG. 1 illustrates a system for resuming processes from checkpoints inside a simulator in accordance with an embodiment of the present invention.

FIG. 2 presents a flowchart illustrating the process of creating a restart checkpoint in accordance with an embodiment of the present invention.

FIG. 3 presents a flowchart illustrating the process of creating a process checkpoint in accordance with an embodiment of the present invention.

FIG. 4 presents a flowchart illustrating the process of resuming a process from a process checkpoint inside a simulator in accordance with an embodiment of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

The data structures and code described in this detailed description are typically stored on a computer readable storage medium, which may be any device or medium that can store code and/or data for use by a computer system. This includes, but is not limited to, magnetic and optical storage devices such as disk drives, magnetic tape, CDs (compact discs) and DVDs (digital versatile discs or digital video discs), and computer instruction signals embodied in a transmission medium (with or without a carrier wave upon which the signals are modulated). For example, the transmission medium may include a communications network, such as the Internet.

System for Resuming Processes from Checkpoints Inside a Simulator

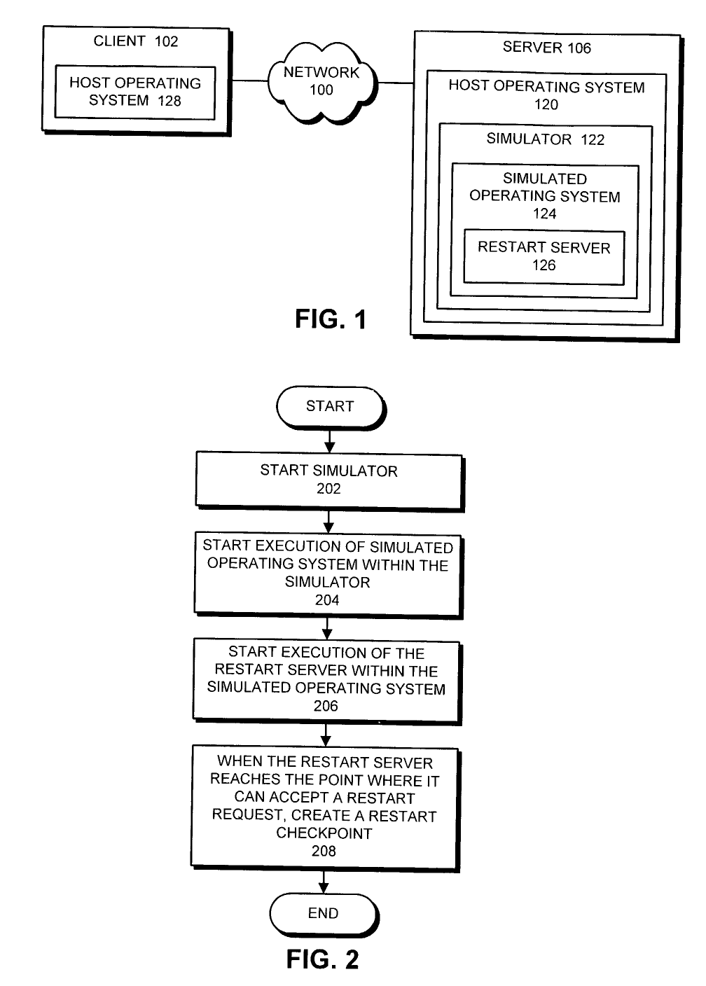

FIG. 1 illustrates a system for resuming processes from checkpoints inside a simulator in accordance with an embodiment of the present invention. This system includes client 102 and server 106 which are coupled together by network 100. Network 100 can generally include any type of wire or wireless communication channel capable of coupling together computing nodes. This includes, but is not limited to, a local area network, a wide area network, or a combination of networks. In one embodiment of the present invention, network 100 includes the Internet. Clients 102 can generally include any node on a network including computational capability and including a mechanism for communicating across the network. Server 106 can generally include any computational node including a mechanism for servicing requests from a client for computational and/or data storage resources.

Server 106 contains host operating system 120. Simulator 122 is a program that runs on host operating system 120. Note that simulator 122 could also be run on host operating system 128 that is located on client 102. Simulated operating system 124 runs inside of simulator 122 and facilitates the execution of programs inside of simulator 122. Restart server 126 is a program that runs on simulated operating system 124 and facilitates restarting processes from process checkpoints inside of simulator 122.

Creating a Restart Checkpoint

FIG. 2 presents a flowchart illustrating the process of creating a restart checkpoint in accordance with an embodiment of the present invention. The system first starts by executing simulator 122 (step 202). Once the simulator starts executing, the system starts execution of simulated operating system 124 within simulator 122 (step 204). Note that simulated operating system 124 is a simulation of an operating system that runs within simulator 122. After simulated operating system 124 has successfully booted, the system starts execution of restart server 126 within simulated operating system 124 (step 206). When restart server 126 reaches the point where restart server 126 can accept a restart request, the system creates a restart checkpoint using a checkpointing mechanism that is part of simulator 122 (step 208). Note that this process needs to be executed only once for each simulated operating system 124. Once the restart checkpoint has been created for a simulated operating system 124, it only needs to be recreated if there is a change to simulated operating system 124, if there is a change to restart server 126, or potentially if there is a change to simulator 122.

Creating a Process Checkpoint

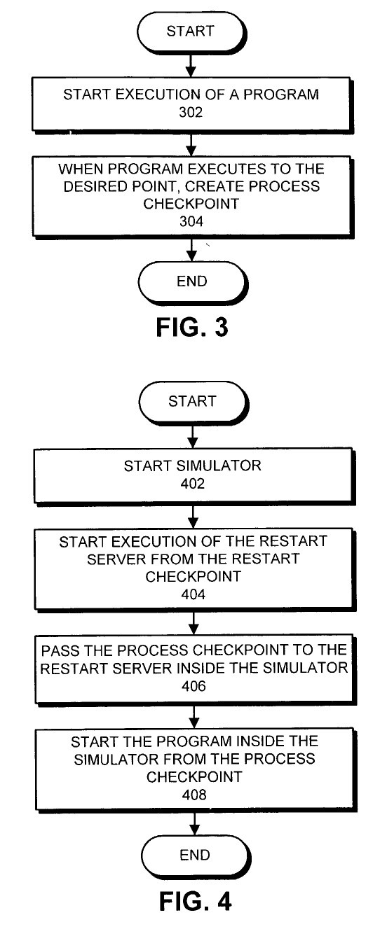

FIG. 3 presents a flowchart illustrating the process of creating a process checkpoint in accordance with an embodiment of the present invention. The system first starts executing a program (step 302). Note that execution of the program can take place either on host operating system 128 within client 102 or on host operating system 120 within server 106. When the program executes to the desired point where further execution is to take place inside simulator 122, the system creates a process checkpoint of the program (step 304). This process checkpoint can be created in a number of ways. It can be created by a program running on host operating system 120. It can be created by a program running on host operating system 128. Alternatively, the process checkpoint can be created by a mechanism built into either host operating system 120 or host operating system 128 as long as the process checkpoint is able to be used by restart server 126.

Resuming a Program from a Process Checkpoint Inside a Simulator

FIG. 4 presents a flowchart illustrating the process of resuming a program from a process checkpoint inside a simulator 122 in accordance with an embodiment of the present invention. This process starts by commencing execution of simulator 122 (step 402). Once simulator 122 is running, the system starts executing restart server 126 along with simulated operating system 124 from the restart checkpoint that was created by the process illustrated in FIG. 2 (step 404). When simulator 122 has successfully resumed execution of restart server 126 from the restart checkpoint, the system passes the process checkpoint, which was created during the process illustrated in FIG. 3, to restart server 126 (step 406). Finally, restart server 126 starts the program from the process checkpoint inside simulator 122 (step 408).

Note that programs can be resumed inside simulator 122 a large number of times from the process checkpoint. However, the cost of executing the program to the desired point needs to be paid only one time. Furthermore, the cost of executing the program to the desired point is reduced because the program can be executed to the desired point outside of simulator 122.

Another embodiment of the present invention provides a system where the checkpointing mechanism internal to simulator 122 is modified to accept checkpoints created outside of simulator 122. This adds a higher degree of complexity because simulator 122 has to be compatible with all of the different versions of simulated operating system 124 as well as being able to accept checkpoints from all of the different versions of host operating system 120.

The foregoing descriptions of embodiments of the present invention have been presented for purposes of illustration and description only. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A method for commencing simulation of a process from a process checkpoint, the method comprising:
receiving the process checkpoint, wherein the process checkpoint was created from the process while the process was running outside of a simulator;
starting simulation of the process from the process checkpoint by, resuming simulation of a restart application within the simulator, wherein the restart application restarts processes from a checkpointed state outside of the simulator,
wherein simulation of the restart application is resumed at a point where the restart application is ready to accept a checkpoint to be restarted, and
using the simulation of the restart application to restart the process from the checkpoint;
whereby the simulation of the process can be commenced from the process checkpoint, without the time-consuming task of having to run the process within the simulator up to the point where the checkpoint was created.

2. The method of claim 1, wherein resuming simulation of a restart application involves loading a restart checkpoint into the simulator, the restart checkpoint having been previously generated by the simulator during execution of the restart application within the simulator.

3. The method of claim 1, wherein prior to resuming simulation of the restart application, the method further comprises generating the restart checkpoint by:
starting an operating system within the simulator;
starting the restart application within the operating system within the simulator; and
when the restart application reaches a point where the restart application can accept a restart request, creating a restart checkpoint.

4. The method of claim 1, wherein prior to receiving the process checkpoint, the method further comprises generating the process checkpoint by:
executing the process outside of the simulator; and
when the process reaches a pre-specified point, creating a checkpoint of the process.

5. The method of claim 1, wherein the restart application is configured to run as a server, whereby the restart application continually accepts restart requests.

6. A method for commencing simulation of a process from a process checkpoint, the method comprising:
receiving the process checkpoint, wherein the process checkpoint was created from the process while the process was running outside of a simulator;
modifying the process checkpoint to a form useable by the simulator's checkpoint program; and
commencing simulation of the process.

7. A computer-readable storage medium storing instructions that when executed by a computer cause the computer to perform a method for commencing simulation of a process from a process checkpoint, the method comprising:
receiving the process checkpoint, wherein the process checkpoint was created from the process while the process was running outside of a simulator;
starting simulation of the process from the process checkpoint by, resuming simulation of a restart application within the simulator, wherein the restart application restarts processes from a checkpointed state outside of the simulator,
wherein simulation of the restart application is resumed at a point where the restart application is ready to accept a checkpoint to be restarted, and
using the simulation of the restart application to restart the process from the checkpoint;
whereby the simulation of the process can be commenced from the process checkpoint, without the time-consuming task of having to run the process within the simulator up to the point where the checkpoint was created.

8. The method of claim 7, wherein resuming simulation of a restart application involves loading a restart checkpoint into the simulator, the restart checkpoint having been previously generated by the simulator during execution of the restart application within the simulator.

9. The method of claim 7, wherein prior to resuming simulation of the restart application, the method further comprises generating the restart checkpoint by:
starting an operating system within the simulator;
starting the restart application within the operating system within the simulator; and
when the restart application reaches a point where the restart application can accept a restart request, creating a restart checkpoint.

10. The method of claim 7, wherein prior to receiving the process checkpoint, the method further comprises generating the process checkpoint by:
executing the process outside of the simulator; and
when the process reaches a pre-specified point, creating a checkpoint of the process.

11. The method of claim 7, wherein the restart application is configured to run as a server, whereby the restart application continually accepts restart requests.

12. A computer-readable storage medium storing instructions that when executed by a computer cause the computer to perform a method for commencing simulation of a process from a process checkpoint, the method comprising:
receiving the process checkpoint, wherein the process checkpoint was created from the process while the process was running outside of a simulator;
modifying the process checkpoint to a form useable by the simulator's checkpoint program; and
commencing simulation of the process.

13. An apparatus for commencing simulation of a process from a process checkpoint, comprising:
a receiving mechanism configured to receive the process checkpoint, wherein the process checkpoint was created from the process while the process was running outside of a simulator;
a simulation mechanism configured to resume simulation of a restart application within the simulator, wherein the restart application restarts processes from a checkpointed state outside of the simulator,
wherein simulation of the restart application is resumed at a point where the restart application is ready to accept a checkpoint to be restarted, and
using the simulation of the restart application to restart the process from the checkpoint;
whereby the simulation of the process can be commenced from the process checkpoint, without the time-consuming task of having to run the process within the simulator up to the point where the checkpoint was created.

14. The apparatus of claim 13, wherein the simulation mechanism is further configured to load a restart checkpoint into the simulator, the restart checkpoint having been previously generated by the simulator during execution of the restart application within the simulator.

15. The apparatus of claim 13, further comprising a checkpoint generation mechanism comprising:
an execution mechanism configured to start an operating system within the simulator;
a secondary execution mechanism configured to start the restart application within the operating system within the simulator; and
a checkpointing mechanism configured to create a restart checkpoint when the restart application reaches a point where the restart application can accept a restart request.

16. The apparatus of claim 13, further comprising:
an external execution mechanism configured to execute the process outside of the simulator; and
a process checkpointing mechanism configured to create a checkpoint of the process when the process reaches a pre-specified point.

17. The apparatus of claim 13, wherein the simulation mechanism is further configured to continually accept restart requests.

18. An apparatus for commencing simulation of a process from a process checkpoint, the method comprising:
a receiving mechanism configured to receive the process checkpoint, wherein the process checkpoint was created from the process while the process was running outside of a simulator;
a modification mechanism configured to modify the process checkpoint to a form useable by the simulator's checkpoint program; and
an execution mechanism configured to commence simulation of the process.
